(19) United States
(12) Patent Application Publication
(10) Pub. No.: US 2017/0020767 A1
(43) Pub. Date: Jan. 26, 2017

(54) BASALT SLEEP MASK

(71) Applicant: Neyda Luz DeMarie, Rahway, NJ (US)

(72) Inventor: Neyda Luz DeMarie, Rahway, NJ (US)

(21) Appl. No.: 15/176,834

(22) Filed: Jun. 8, 2016

Related U.S. Application Data
(60) Provisional application No. 62/196,913, filed on Jul. 25, 2015.

(51) Int. Cl. A61H 7/00; A61H 39/04; A61H 23/00

(52) U.S. Cl. CPC A61H 7/001; A61H 23/00; A61H 39/04; A61H 2205/023; A61H 2205/025; A61H 2205/024

(57) ABSTRACT

A sleep mask is provided for. This sleep mask preferably features a nose bridge which has at least one substantially hollow chamber and two inner sections which each have a first part and a second part. The first part has a non-uniform height and an inner volume, and the second part has a smaller volume than the first part. The sleep mask also features two outer sections, each of which have a height and a pocket, where each of the two outer sections envelopes one of the two inner sections and is attached to the nose bridge. The substantially hollow chamber, the inner volume of the two inner sections, and the pocket of the two outer sections is filled with a granular material, which is preferably pulverized igneous basalt rock.

### CLAIM OF PRIORITY

This application claims priority to U.S. Provisional Patent Application No. 62/196,913, filed on Jul. 25, 2015.

### FIELD OF THE EMBODIMENTS

The field of the present invention and its embodiments relate to a sleep mask that provides numerous health benefits.

### BACKGROUND OF THE EMBODIMENTS

Practitioners of reflexology believe that due to the application of pressure to given areas in the body, it is possible to effectuate change in corresponding organs. That is, there exist various zones throughout the body that correspond to various organs. Through the selective application of pressure, practitioners believe that is possible to create medical benefits to a user.

Additionally, in its natural state, igneous basalt rock has been reported to exhibit healing properties. This could be by accelerating cell regeneration, detoxifying the body, and by rejuvenating the skin and muscle tissue.

The connective tissue such as ligaments and tendons are chief in holding tension in the muscle tissue. As these ligaments get injured due to physical or emotional trauma, stress, illness and dehydration they stiffen and repairs at a much slower pace. It will also slow the body's natural healing process. As the health and elasticity of the connective tissue is improved vital nutrients and moisture can circulate freely and nourish the tissue and organs with more efficiency to improve the overall health and appearance of the skin. The end result including a natural and gentle postural realignment is over all good health, improved homeostasis with noticeably decreased facial lines and wrinkles and a radiant skin tone.

Review of related technology:

U.S. Pat. No. 5,314,456 pertains to a therapeutic pad for relief of headache-associated head, temple, neck and upper back pain includes a lower portion substantially defining, in surface geometry, a rectangle having major and a minor bases and, further, having an axis of symmetry co-parallel to the minor bases. The therapeutic pad also includes an upper portion substantially defining, in surface geometry, an elongate wing-like shape having a major axis of about double the length of the major bases of the rectangle of the lower portion, and having a minor axis which is an axis of symmetry co-linear to the axis of symmetry of the lower portion. The upper portion includes elements for selectably securing to each other portions of lateral ends of the wing-like shape. The therapeutic pad also includes a connecting portion defining an isthmus between the lower and upper portions, the geometry of the connecting portion having an axis of symmetry co-linear with the axes of symmetry of the upper and lower portions, the connecting portion also having a major axis trans-verse to its axis of symmetry, said major axis having a length of about one-half of the major bases of the rectangle of the lower portion. The therapeutic pad is provided with elements for providing therapeutic inputs, which are embedded within each of the portions of the pad.

U.S. Pat. No. 5,738,624 pertains to a face mask for applying a magnetic flux field to the face of a human being comprises sheets of flexible plastic material joined together to provide a pocket therebetween containing a formable material by which the mask is adapted to conform to the contour of the face of person wearing the mask. The formable material can be a viscous liquid or thermoplastic material, and the mask is provided with permanent magnet sheet elements which overlie forehead, temple, cheek and mouth areas of the face and are urged to lie parallel thereto by the deformable material.

U.S. Pat. No. 6,972,029 pertains to a garment for warming, cooling or maintaining the temperature of a specific area of a user's body includes a hoop-shaped support structure, at least one pocket on the support structure and at least one mass. The mass is removably positionable in the at least one pocket. The garment is worn by a user such that the at least one pocket is positioned adjacent the specific area of the user's body in a working position.

U.S. Patent Publication No. 2008/0058915 pertains to a facial membrane mask and its device for cosmetic and health care applications. This invention is particularly related to transcutaneous electric acupoint stimulators and cosmetic facial membrane masks. The combination of these two devices results in synergistic effects. This invention uses a facial membrane mask that can absorb skin care solution. Electrodes are integrated with the membrane at the positions which correspond to facial acupoints. When the wet facial membrane mask covers the face, the electric pulses generated by the stimulator can stimulate the corresponding acupoints, nerve or muscle. The stimulation results in acupuncture or massage effects. Therefore, both the traditional facial membrane's skin care effects, such as moisturizing and whitening etc., and acupuncture/massage effects can be obtained concurrently. Being able to modulate facial meridians and improve subcutaneous blood circulation, this invention is useful for cosmetic and health care purposes.

U.S. Patent Publication No. 2008/0306507 pertains to a therapeutic beauty mask comprising a mask body, means for attaching and securing the body to cover at least a portion of a person's face, and a plurality of pressure points extending from an undersurface of the mask body, said pressure points being adapted or adjustable to coincide with known acupressure points of the human face.

International Patent Document No.: WO2005058227 pertains to a therapeutic sand bath which consists of adding to the grains of sand another component which is chemically neutral in the range of temperatures having a therapeutic effect, cools down slowly and exhibits a high specific heat capacity.

International Patent Document No. WO2013032152 pertains to a facial mask having an electromagnetic emission function, wherein skin permeability of ionic drugs and nutrients can be increased. The facial mask according to the present invention comprises: an external silicone layer which includes a facial molding unit that has the shape of a human face and is applied with a silicone material, and a control device that accommodates a battery by being positioned on one end of the facial molding unit and adjusts an electromagnetic wave output according to a user selection; a shielding layer which is bonded with the lower part of the external silicone layer, and shields electromagnetic waves emitted to the outside; a circuit layer which is adhered to a lower end of the shielding layer, has at least one antenna for radiating the electromagnetic waves, includes a control circuit that delivers a control signal for electromagnetic wave radiation to the at least one antenna according to a control command of the control device, and receives power from the control device, and then delivers the electromagnetic waves to the at least one antenna by responding to a plurality of switching operations; and an internal silicone layer which is positioned on the lower part of the circuit layer, accommodates the shielding layer and the circuit layer by being pressed and coming into close contact with the external silicone layer, and is in contact with the human face. Thus, the invention provides the effect of facial muscle relaxation and increases user convenience of a facial electromagnetic wave radiation mask since a pad for radiating electromagnetic waves is manufactured in the shape of a face.

European Patent Document No. EP0071211 pertains to a flexible flat composite body for external application in the treatment of a body having in its simplest form of construction, an actively needlebondable fiber layer, a counter layer and an intermediate layer of rock particles such as sand, chips and the like. The fiber layer and the counter layer are needle-bonded to each other through the intermediate layer. The counter layer may consist of a layer of fibers or a soft, elastic synthetic plastic sheet. It may have bowl like depressions to be willed with rock particles.

Various systems and methodologies are known in the art. However, their structure and means of operation are substantially different from the present disclosure. The other inventions fail to solve all the problems taught by the present disclosure. The present invention and its embodiments provide a means to protect a tow truck operator from a tow cable breaking. At least one embodiment of this invention is presented in the drawings below and will be described in more detail herein.

### SUMMARY OF THE EMBODIMENTS

The present invention provides for a sleep mask, comprising: a nose bridge, having at least one substantially hollow chamber; two inner sections, each of the two inner sections having a first part and a second part, wherein the first part has a non-uniform height and an inner volume, wherein the second part has a smaller volume than the first part; two outer sections, each having a height and a pocket, wherein each of the two outer sections envelopes one of the two inner sections and is attached to the nose bridge, wherein the at least one substantially hollow chamber, the inner volume of the two inner sections, and the pocket of the two outer sections is filled with a granular material. In some embodiments the sleep mask comprises two upper lobes, and two lower lobes, wherein the two upper lobes and two outer lobes extend away from each other, and wherein the two upper lobes and two outer lobes extend away from the nose bridge. In other preferred embodiments, the sleep mask is constructed out of soft stretch cloth. In other embodiments, the nose bridge, two inner sections, and two outer sections are connected by at least one fiber and preferably the sleep mask further comprises a cover.

In some embodiments, the two outer sections are configured to stimulate a user's heart, gall bladder, stomach, lung, bladder, and colon and in other embodiments, the two inner portions are configured to stimulate a user's heart, kidney, and stomach. In other preferred embodiments, the nose bridge is configured to stimulate a user's pancreas, liver, and small intestine. Preferably, the nose bridge has a length and width, wherein the length is 6 centimeters, and wherein the width is 2.5 centimeters. In some embodiments, the distance between the two inner sections is 6.5 centimeters and in others the second part is an ellipse with a height and width, wherein the height is 1.5 centimeters and the width is 2.8 centimeters. Further, the sleep mask has a width, which is preferably 21 centimeters. In an exemplary embodiment, the granular material is pulverized basalt igneous rock. There also exist embodiments where the sleep mask also has a plurality of motors configured to cause the sleep mask to vibrate, when desired. Also preferably, the cover of the sleep mask is constructed out of a non-porous material.

The present invention also provides for a method of relaxing at least one facial muscle, comprising the steps of: providing, a sleep mask, comprising: a nose bridge, having at least one substantially hollow chamber; two inner sections, each of the two inner sections having a first part and a second part, wherein the first part has a non-uniform height and an inner volume, wherein the second part has a smaller volume than the first part; two outer sections, each having a height and a pocket, wherein each of the two outer sections envelopes one of the two inner sections and is attached to the nose bridge, wherein the at least one substantially hollow chamber, the inner volume of the two inner sections, and the pocket of the two outer sections is filled with a granular material; placing, the sleep mask, on a user's face; applying pressure, by the sleep mask, to particular areas on a user's face; simulating reflexology treatment, by maintaining pressure on the user's face, while allowing them to breath, causing the granular material to shift; removing the sleep mask, after at least one of a user's facial muscles have been relaxed. Preferably, the sleep mask is placed on the user's face such that the second part of the sleep mask is over the user's eyes when this method is performed. Alternatively, the sleep mask is placed on the user's face such that the sleep mask rests substantially on a user's forehead while the method of the present invention is being performed. In many embodiments, multiple facial muscles are relaxed simultaneously while the method of the present invention is being performed.

When placing the mask over a user's eyes for a few minutes at room temperature, the basalt stone stimulates circulation as it softens the aponeurosis, fascia and muscle tissue. The sleep mask relieves the tension in the area in which is applied to and promotes deep relaxation. A tiny magnetic vibration creates suction between the stone and the fascia which draws the tension from the surrounding connective tissue. As the muscles relax the user falls into a deep state of relaxation with the majority of users falling asleep within minutes. Inflammation in the fascia is reduced as cellular debris and toxins are expelled from the relaxed muscle fibers. The circulatory system carries the waste out and away to be processed by the lymphatic system. The gentle pressure and magnetic stimulation of the stone over the nasal bone helps reduce sinus congestion and the pressure associated with it, giving the user the ability to breathe comfortably with an increase in oxygen intake. This detoxification improves the overall health of cells as well as it aids in cell regeneration.

After a few months of consistent use a natural postural realignment will occur as small adjustments along the spinal cord and eventually the joints of the limbs also begin to realign. Placing the mask over your eyes for a few minutes at room temperature, basalt stone will stimulate circulation as it softens the aponeurosis, fascia and muscle tissue. The present invention relieves the tension in the area in which is applied to and promotes deep relaxation. A tiny magnetic vibration caused by the basalt creates suction between the present invention and a user's fascia, drawing the tension from the surrounding connective tissue. As the user's muscles relax, the user will fall into a deep state of relaxation. For the majority of users this will happen in less than 20 minutes Inflammation in the fascia is reduced as cellular debris and toxins are expelled by the body from the relaxed muscle fibers. The circulatory system carries the waste out and away to be processed by the lymphatic system.

Further, the gentle pressure and magnetic stimulation of the stone over a user's nasal bone helps reduce sinus congestion and the pressure associated with it, giving the user the ability to breathe comfortably with increased oxygen intake. This detoxification improves the overall health of cells and it aids in cell regeneration. After a few months of consistent use, a natural postural realignment will occur, as small adjustments along the spinal cord and eventually the joints of the limbs also begin to realign. Connective tissues such as ligaments and tendons are primarily responsible for holding tension in muscle tissues. As these connective tissues get injured they stiffen and get repaired at a much slower pace. It will also slow the body's natural healing process. As the health and elasticity of the connective tissue is improved, vital nutrients and moisture can circulate freely and nourish the tissue and organs with more efficiency to improve the overall health and appearance of the skin.

In general, the present invention succeeds in conferring the following, and others not mentioned, benefits and objectives.

It is an object of the present invention to provide a means to promote restful sleep.

It is an object of the present invention to provide a means to relax facial tension lines.

It is an object of the present invention to provide a means to detoxify cells.

It is an object of the present invention to provide a means to improve circulation.

It is an object of the present invention to provide a means to reduce inflammation.

It is an object of the present invention to provide a means to promote overall relaxation.

It is an object of the present invention to provide a means to improve skin tone and texture.

It is an object of the present invention to provide a means to diminish deep wrinkle lines.

It is an object of the present invention to provide a means to improve skin elasticity.

It is an object of the present invention to provide a means to reduce sinus inflammation.

It is an object of the present invention to provide a means to improve a user's overall health and well-being.

### BRIEF DESCRIPTION OF THE DRAWINGS

FIG. 1 is a perspective view of an embodiment of the present invention.

FIG. 2 is a top view of an embodiment of the present invention.

FIG. 3 is a bottom view of an embodiment of the present invention.

FIG. 4 is a left side view of an embodiment of the present invention.

FIG. 5 is a right side view of an embodiment of the present invention.

FIG. 6 is a front view of an embodiment of the present invention.

FIG. 7 is a rear view of an embodiment of the present invention.

FIG. 8 is a perspective view of an alternative embodiment of the present invention.

FIG. 9 is a top view of an alternative embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

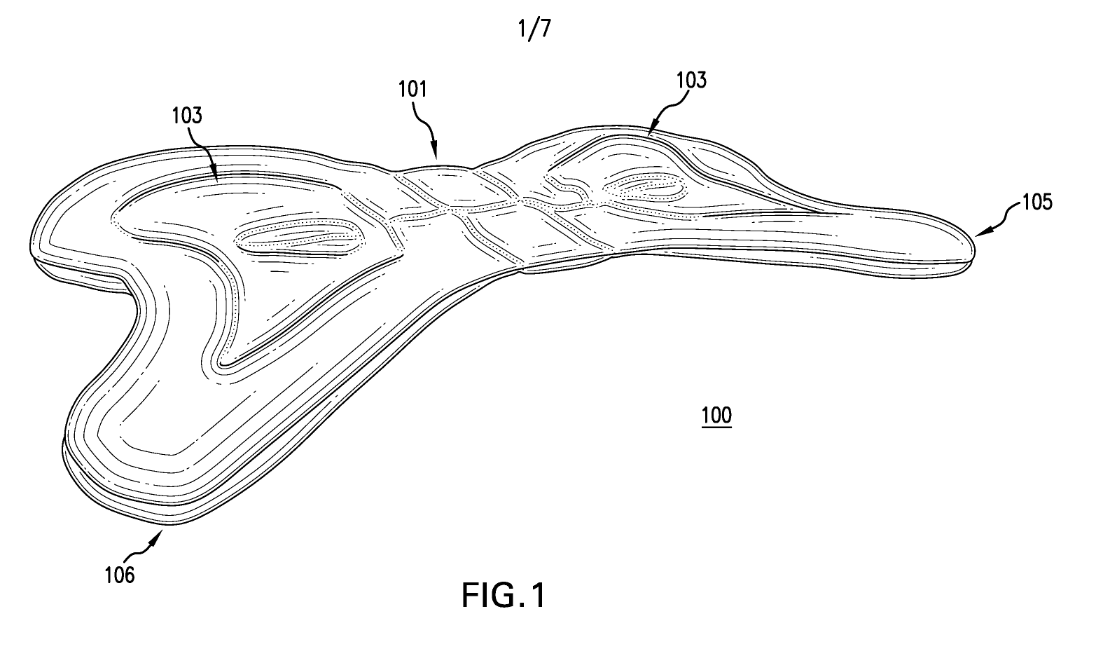

Referring to FIG. 1, sleep mask 100 is provided. Here, sleep mask 100 features nose bridge 101, two inner sections 103, and two outer sections 106. Together, these components create an embodiment of sleep mask 100 that corresponds to the features of a human face, and in particular corresponds to specific pressure points that exist on the human face. In a preferred embodiment, sleep mask 100 is shaped to stimulate pressure points in accordance with the teachings of reflexology. According to traditional Chinese medicine, various pressure points on the human face correlate to different body parts. As the facial reflex points are stimulated the corresponding body part will relax allowing the user achieve full body relaxation. Specifically, this embodiment of the present invention will stimulate and soften trigger points of the facial muscles with origins in the frontal, temporal, zygomatic, nasal, maxilla, mandible and sphenoid bones. The mask is worn over the eyes and can be inverted and placed over the mouth to target tension lines and stress around the lips, jaw and chin. Due to its symmetry and balance it can also be placed laterally on either side of the face or forehead targeting tension wherever it is trapped.

In this, and other embodiments, two outer sections 106 are configured to stimulate a user's heart, gall bladder, stomach, lung, bladder, and colon; two inner portions 103 are configured to stimulate a user's heart, kidney, and stomach; and nose bridge 101 is configured to stimulate a user's pancreas, liver, and small intestine.

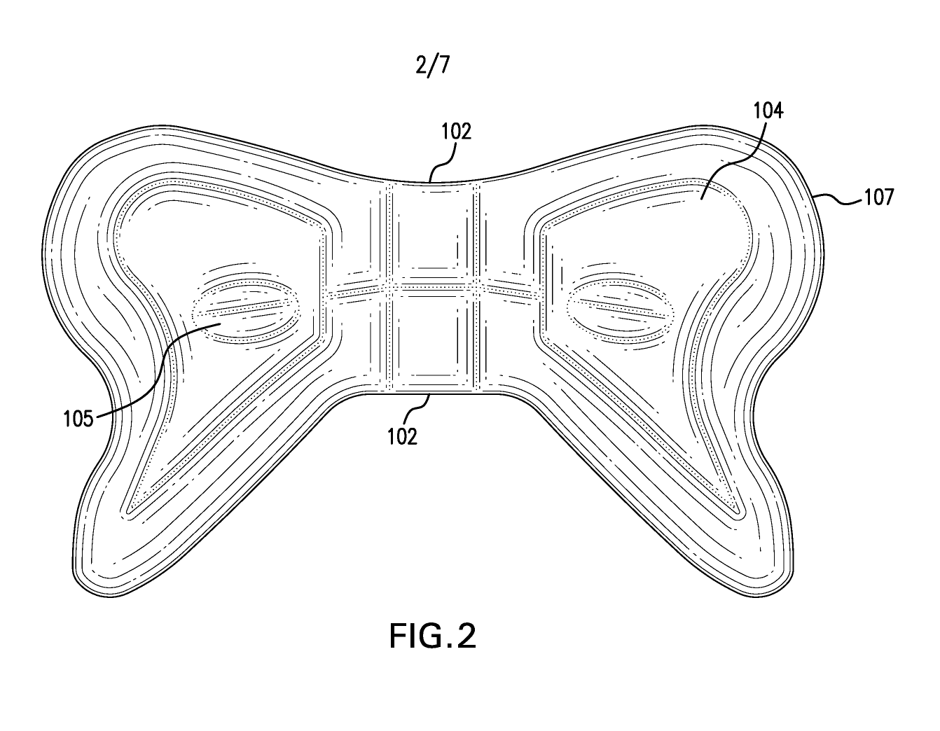

Referring to FIG. 2, a top view of an embodiment of the present invention is shown. Here, substantially hollow chamber 102, first part 104, second part 105, and pocket 107 are shown. In this embodiment, all of these components have an inner volume which is preferably filled with a granular material. Specifically, first part 104 exerts pressure on a user's face such that the user's heart, kidney, and stomach are relaxed by the present invention. Various granular materials are suitable for use with the present invention. While basalt igneous rock is used in a highly preferred embodiment, any pulverized mineral aggregate can be used, as well as ground minerals, metal, crystals, quartz, precious gems, semiprecious gems, silica, marble, granite, marcasite, hematite, iron, copper, platinum, silver, gold glass, amethyst, and rice, small grains, seeds, nuts, chorused shells, coral, and plastic beads may be used as the granular material of the present invention.

When the present invention rests on a user's face, it quickly induces a deep sleep in the user due to the user being so relaxed. On average, 90% of the users will fall into a deep (REM) sleep within 20 minutes of placing the present invention on their face. Further, the present invention is capable of diminishing wrinkles. This is due to trigger points being stimulated and tension is released from the soft tissue the user acquires an appearance of a fresh look, with softened tension lines. Repeated stimulation of the Ayurveda rejuvenating points in time erases fine lines & decreases the grooves of deep winkles.

Additionally, the present invention is capable of reliving sinus inflammation. This is achieved by alleviating the pressure around the sinus points, allowing for better oxygen intake. For the majority of users this relaxation causes reduced snoring during sleep and in some cases snoring is eliminated altogether.

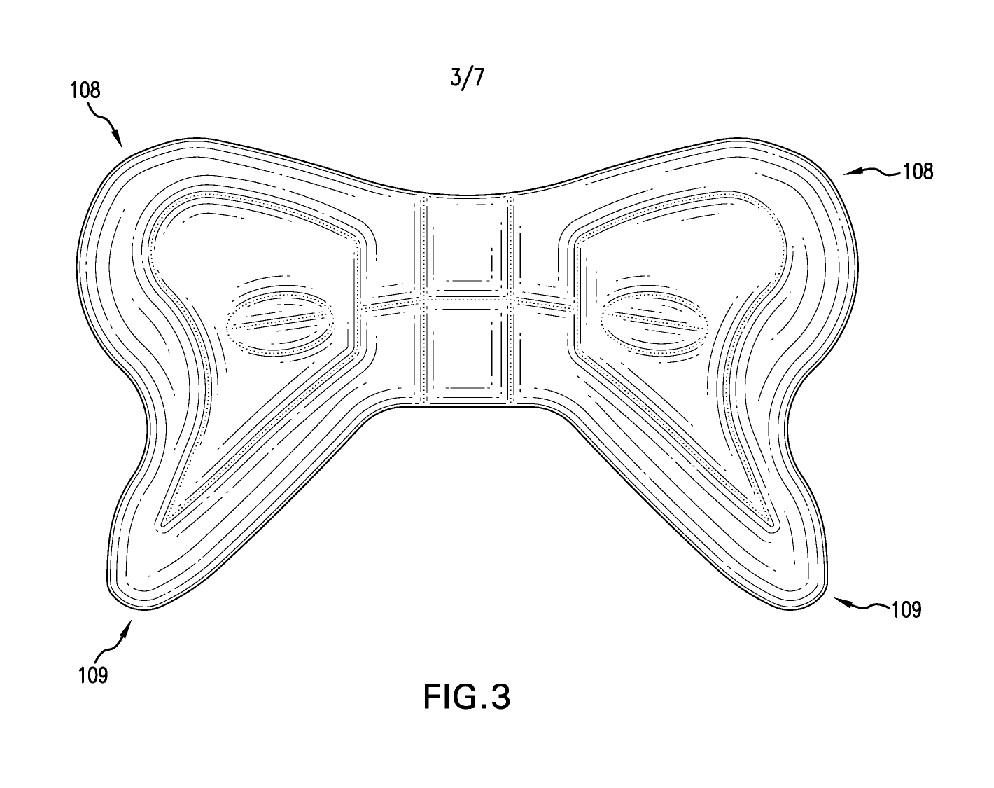

FIG. 3 shows a bottom view of an embodiment of the present invention. As can be seen, the bottom of this embodiment is identical to the top of this embodiment. That is, both the top and bottom of the present invention have corresponding volumes and are equally capable of stimulating pressure points of a human face. Specifically, this view shows two upper lobes 108 and two lower lobes 109. These lobes give this embodiment of the present invention shape, although there exist other embodiments that do not contain two upper lobes 108 or two lower lobes 109. The present invention is also capable of detoxifying cells as basalt stone has been used by the health and beauty industry as a metabolic detox, whether ingested or applied topically. The present invention has the ability to detoxify cells by stimulating the nervous and circulatory systems. When the muscles in the face relax, metabolic waste is released into the blood stream and is subsequently processed and eliminated by the lymphatic system. Additionally, the present invention can improve a user's circulation, through this same process.

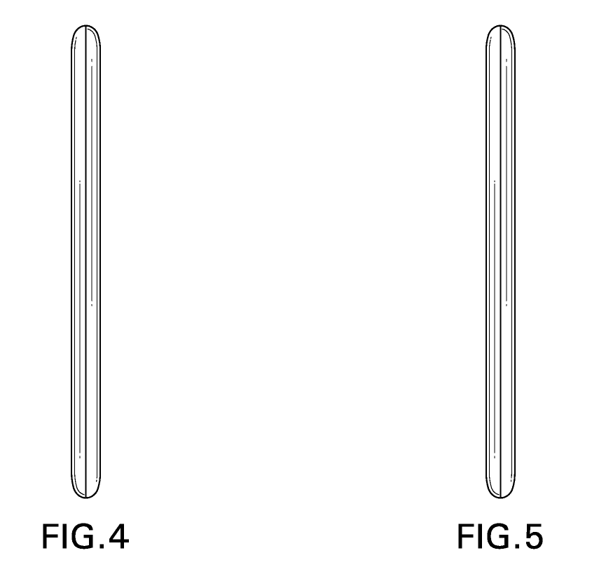

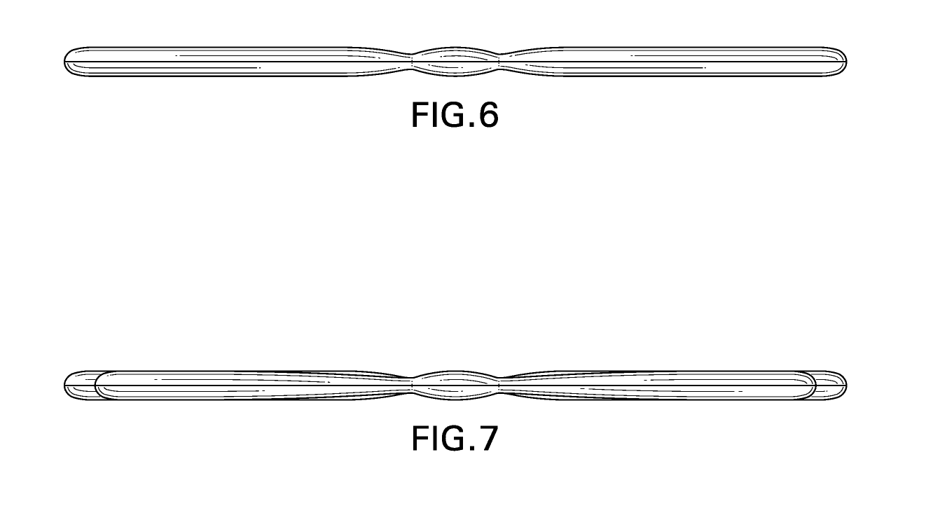

FIGS. 4-7 show various view of the embodiment of the present invention shown in FIG. 1.

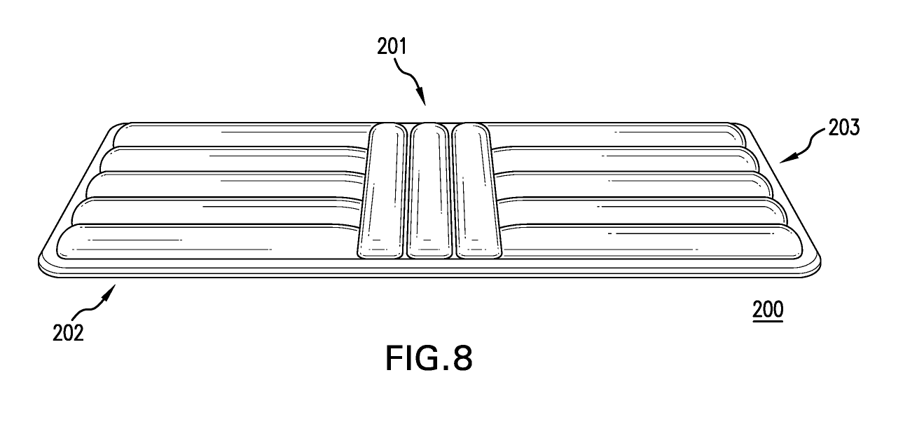

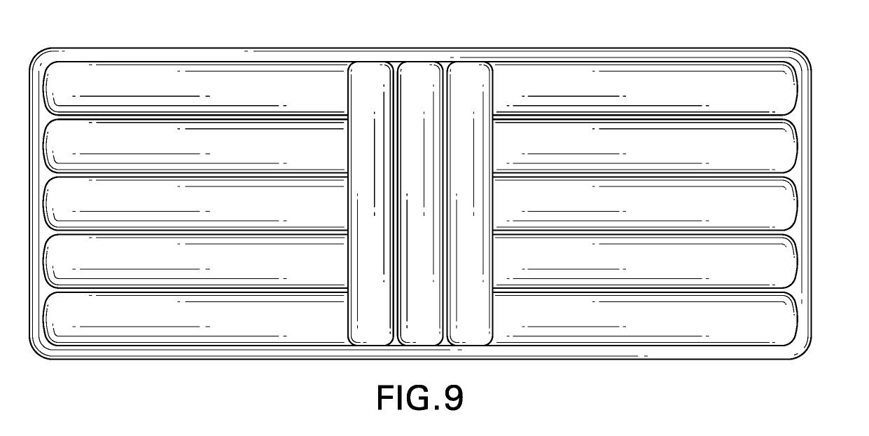

FIG. 8 shows an alternative embodiment of the present invention. This view shows sleep mat 200, featuring first plurality of substantially cylindrical chambers 201, second plurality of substantially cylindrical chambers 202, and third plurality of substantially cylindrical chambers 203. As can be seen by this view, first plurality of substantially cylindrical chambers 201 is in a perpendicular orientation with respect to second plurality of substantially cylindrical chambers 202, and third plurality of substantially cylindrical chambers 203. All of these chambers are preferably filled with basalt igneous rock, but all of the previously mentioned granular materials are suitable for use in this embodiment as well. Preferably, the present invention is constructed out of soft-stretch cloth.

It should be noted that the present invention may take additional shapes such as an oval, circle, heart, triangle, tooth, or a regular polygon. Further, the present invention may be used on other parts of the body such as torso, wrist, elbow, knee, and ankle. The size of the present invention will preferably change for these different uses. The present invention may come in a variety of sizes, such as 20″ wide, 40″ wide, and may be in a 6′×4′ configuration to be used on a bed. Further, embodiments exist where the present invention is fastened to a user via at least one strap.

In a preferred embodiment, the present invention is equipped with an audio device capable of play pre-recorded audio. In another preferred embodiment, the present invention is imbued with a particular fragrance. Preferably this fragrance will help a user relax. Other embodiments exist where a heating element is incorporated into the present invention. Preferably, the present invention will be equipped with a cover. This cover may have ornamental designs on it, and may be constructed out of soft-stretch cloth, vinyl, or plastic. In yet another preferred embodiment, the present invention is equipped with at least one motor so that it may vibrate. The sleep mask of the present invention may also be constructed out of soft-stretch cloth.

In another preferred embodiment, the sleep mask of the present invention spans a user's chin to their forehead. This provides for full coverage of the user's face.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A sleep mask, comprising:
a nose bridge, having at least one substantially hollow chamber;
two inner sections, each of the two inner sections having a first part and a second part,
wherein the first part has a non-uniform height and an inner volume,
wherein the second part has a second volume,
wherein the second volume is smaller than the inner volume;
two outer sections, each having a height and a pocket,
wherein each of the two outer sections envelopes one of the two inner sections and is attached to the nose bridge,
wherein the at least one substantially hollow chamber, the inner volume of the two inner sections, and the pocket of the two outer sections is filled with a granular material.

2. The sleep mask of claim 1, wherein the sleep mask further comprises two upper lobes, and two lower lobes,
wherein the two upper lobes and two lower lobes extend away from each other, and
wherein the two upper lobes and two lower lobes extend away from the nose bridge.

3. The sleep mask of claim 1, wherein the sleep mask is constructed out of soft stretch cloth.

4. The sleep mask of claim 1, wherein the nose bridge, two inner sections, and two outer sections are connected by at least one fiber.

5. The sleep mask of claim 1, further comprising a cover.

6. The sleep mask of claim 1, wherein the two outer sections are configured to stimulate a user's heart, gall bladder, stomach, lung, bladder, and colon.

7. The sleep mask of claim 1, wherein the two inner portions are configured to stimulate a user's heart, kidney, and stomach.

8. The sleep mask of claim 1, wherein the nose bridge is configured to stimulate a user's pancreas, liver, and small intestine.

9. The sleep mask of claim 1, wherein the nose bridge has a length and width,
wherein the length is 6 centimeters, and
wherein the width is 2.5 centimeters.

10. The sleep mask of claim 1, wherein the distance between the two inner sections is 6.5 centimeters.

11. The sleep mask of claim 1, wherein the second part is an ellipse with a height and width,
wherein the height is 1.5 centimeters and the width is 2.8 centimeters.

12. The sleep mask of claim 1, wherein the sleep mask has a width,
wherein the width is 21 centimeters.

13. The sleep mask of claim 1, wherein the granular material is pulverized basalt igneous rock.

14. The sleep mask of claim 1, further comprising a plurality of motors configured to vibrate the sleep mask.

15. A sleep mat, comprising:
a first plurality of substantially cylindrical chambers
a second plurality of substantially cylindrical chambers, and
a third plurality of substantially cylindrical chambers,
wherein each substantially cylindrical chamber has an inner volume which contains a volume of basalt igneous rock,
wherein the second plurality of substantially cylindrical chambers and third plurality of substantially cylindrical chambers are parallel to each other, and
wherein the first plurality of chambers is perpendicular to the second plurality of substantially cylindrical chambers and the third plurality of substantially cylindrical chambers.

16. A method of relaxing at least one facial muscle, comprising the steps of:
providing, a sleep mask, comprising:
a nose bridge, having at least one substantially hollow chamber;
two inner sections, each of the two inner sections having a first part and a second part,
wherein the first part has a non-uniform height and an inner volume,
wherein the second part has a smaller volume than the first part; two outer sections, each having a height and a pocket,
wherein each of the two outer sections envelopes one of the two inner sections and is attached to the nose bridge,
wherein the at least one substantially hollow chamber, the inner volume of the two inner sections, and the pocket of the two outer sections is filled with a granular material;
placing, the sleep mask, on a user's face;
applying pressure, by the sleep mask, to particular areas on a user's face;
simulating reflexology treatment, by maintaining pressure on the user's face, while allowing the user to breath, causing the granular material to shift;
removing the sleep mask, after at least one of a user's facial muscles have been relaxed.

17. The method of claim 14, wherein the sleep mask is placed on the user's face such that the second part of the sleep mask is over the user's eyes.

18. The method of claim 14, wherein the sleep mask is placed on the user's face such that the sleep mask rests substantially on a user's forehead.

19. The method of claim 14, wherein the sleep mask is placed on the user's face.

20. The method of claim 14, wherein multiple facial muscles are relaxed simultaneously.
